(19) United States
(12) Patent Application Publication
(10) Pub. No.: US 2026/0001204 A1
(43) Pub. Date: Jan. 1, 2026

(54) TOOL FOR INSTALLATION, MANIPULATION, AND REMOVAL OF HOG RINGS

(71) Applicant: Snap-on Incorporated, Kenosha, WI (US)

(72) Inventor: David T. Doyle, Pleasant Prairie, WI (US)

(73) Assignee: Snap-on Incorporated, Kenosha, WI (US)

(21) Appl. No.: 18/758,302

(22) Filed: Jun. 28, 2024

(51) Int. Cl. B25B 27/14

(52) U.S. Cl. CPC B25B 27/146

(57) ABSTRACT

A tool includes first and second halves pivotally coupled together at a pivot and having respective first and second jaw portions with respective first and second front faces. The first and second jaw portions have respective first and second contact surfaces disposed proximal to the front faces, and when the first and second contact surfaces are brought together, they cooperatively define a contact plane that extends along a longitudinal axis of the tool. The jaw portions respectively include first and second relief regions having a depth from the contact plane and respective first and second grooves disposed in the relief regions, wherein the first and second grooves are offset by an offset distance.

### BACKGROUND OF THE INVENTION

The present invention relates to tools that can be utilized for installation, manipulation, and removal of retaining rings, such as hog rings.

Hog rings, among other retaining rings and clasps, are commonly used with automotive car seats to hold upholstered seat covers onto internal seat foam by way of integrated rails in each. These rails are secured to each other by collapsing a hog ring around the two rails. The hog rings are collapsed using conventional hog ring pliers. However, when a repair to an automotive car seat to replace upholstery or make a repair to something inside the seat, the existing hog rings that were initially installed must be removed, and then new hog rings must be installed after the repair is complete.

Conventionally, technicians use a first tool, such as a cutter pliers, to cut and remove the previously installed hog rings before they are able to perform their repair. Then, after the repair is complete, hog ring pliers are used to install new hog rings. Additionally, some hog rings are specifically manufactured for pliers containing auto-feed mechanisms (similar to staples for a stapler or nails for a nail gun). When such hog rings are used outside of the auto-feed mechanisms, the hog rings must be manually separated before use.

However, existing hog ring pliers do not contain geometry that allows them to grip and separate hog rings that are connected together for use in an auto-feed mechanism.

### SUMMARY OF THE INVENTION

The present invention relates broadly to a tool for retaining ring, such as hog rings, installation, manipulation, and/or removal. The tool is a pliers type tool that includes jaw portions having respective external geometries that improve the functionality during both installation, manipulation and/or removal of hog rings, which conventionally requires multiple different types of tools. This allows the tool to grip and manipulate hog rings, while also providing geometry to correctly form and secure the hog rings around workpieces to be secured or fastened together. The jaw portions include respective relief regions to hold a portion of a hog ring to separate a hog ring connected to other hog rings or to remove a hog ring that was collapsed. The jaw portions also respectively include grooves that are adapted to engage the hog ring before and during the installation process. The grooves are offset from each other by a distance, which allows the legs of the hog ring to be collapsed without impinging on one another.

In an embodiment, the present invention includes first and second pliers-type halves pivotally coupled together at a pivot and having respective first and second jaw portions having respective first and second front faces. The first and second jaw portions have respective first and second contact surfaces disposed proximal to the front faces, and when the first and second contact surfaces are brought together (such as when the pliers are closed) they cooperatively define a contact plane that extends substantially along a longitudinal axis of the tool. The jaw portions include first and second relief regions having a depth from the contact plane and respective first and second grooves disposed in the relief regions, wherein the first and second grooves are offset by an offset distance.

In another embodiment, the present invention includes pliers-type tool for removing, manipulating and/or installing a hog ring. The tool includes first and second halves pivotally coupled together at a pivot, first and second jaw portions corresponding to the first and second halves, first and second relief regions on the respective first and second jaw portions, first and second grooves in the respective first and second relief portions, where the grooves are positioned such that the grooves are offset from each other, and first and second contact surfaces disposed on the first and second jaw portions and positioned distal from the pivot.

### BRIEF DESCRIPTION OF DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a top view of a first side of a hog ring tool, according to an embodiment of the present invention.

FIG. 2 is a sectional view of the hog ring tool of FIG. 1 taken along line B-B of FIG. 1.

FIG. 3 is a perspective side view of a jaw portion of the hog ring tool of FIG. 1.

FIG. 4 is a side view of a first half of the hog ring tool of FIG. 1.

FIG. 5 is an enlarged partial view of the hog ring tool of FIG. 1, where the first jaw portion is sectioned along the line A-A shown in FIG. 4.

FIG. 6 is a side view of the hog ring tool of FIG. 1 with the jaws in an open configuration and a hog ring disposed between the jaws.

FIG. 7 is a side, perspective partial view of the hog ring tool of FIG. 6.

FIG. 8 is a side view of the hog ring tool of FIG. 1 with the jaws in a closing configuration and a hog ring disposed between the jaws.

FIG. 9 is a side, perspective partial view of the hog ring tool of FIG. 8.

FIG. 10 is a perspective view the hog ring tool of FIG. 1 showing engagement with auto-feed hog rings.

FIG. 11 is another perspective view the hog ring tool of FIG. 1.

### DETAILED DESCRIPTION OF THE INVENTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention, but is instead used to discuss exemplary embodiments of the invention for explanatory purposes only.

The present invention relates broadly to a tool for removing, manipulating and/or removing retaining rings, such as hog rings. The present invention includes a jaw configuration that incorporates novel geometry that improves the functionality during both installation, manipulation, and/or removal of hog rings, which typically requires use of multiple different tools. The geometry allows the tool to grip and manipulate hog rings, while also providing the ability to correctly form and secure the hog rings around workpieces to be fastened together.

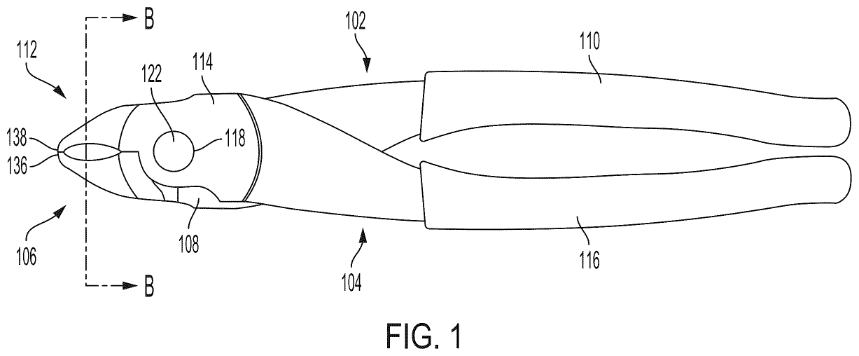

Referring to FIGS. 1-11, a tool 100, such as a pliers-type tool, includes first and second halves 102, 104. The first half 102 includes a first jaw portion 106, a first joint portion 108, and a first handle 110. The first portion can include a first pivot aperture 118. The first pivot aperture 118 may be disposed in the first joint portion 108. The second half 104 includes a second jaw portion 112, a second joint portion 114, and a second handle 116. The second half 104 can include a second pivot aperture 120 adapted to axially align with first pivot aperture 118 and receive a pivot 122 to pivotally couple the first half 102 and the second half 104 together. The pivot 122 may be a fastener, such as a screw, pin, or rivet, thus allowing the first and second portions to be pivotally relative to each other. It will be appreciated that the first and second jaw portions 106, 112 may have substantially similar respective geometries, thus mirroring each other. It will also be appreciated that jaw portions 106, 112 may be asymmetrical. The halves 102, 104 are pivotably coupled and the jaw portions 106, 112 move in a pivot plane relative to each other that is substantially perpendicular to the axis of the pivot 122.

The first and second jaw portion 106, 112 may include respective: first and second relief regions 124, 126; first and second contact surfaces 128, 130; first and second grooves 132, 134; and first and second front faces 136, 138. The respective geometries of the jaw portions 106, 112 may be adapted to cooperatively grip and manipulate retaining rings, such as hog rings, for installing, manipulating and/or removing the hog rings. As depicted in FIG. 1, the first and second halves 102, 104 are disposed in a closed position.

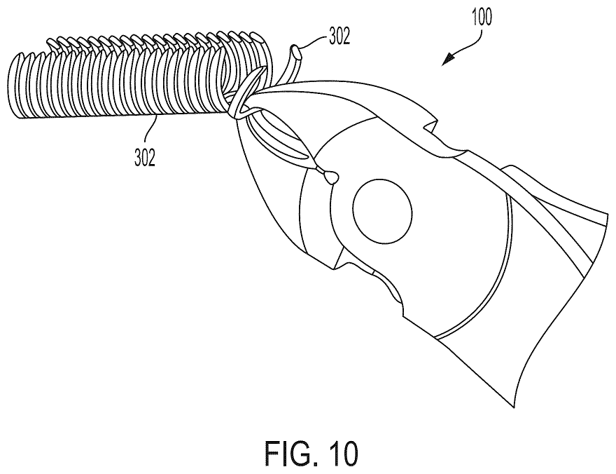

The contact surfaces 128, 130 are respectively disposed proximal to front faces 136, 138 and each has a length 206 extending in a direction substantially parallel to the longitudinal axis of the tool, and each has a width that is substantially perpendicular to the length 206. While the contact surfaces 128, 130 are shown as having a substantially rectangular shape, it will be understood that other geometries could also be used. The contact surfaces 128, 130 may be adapted to abut each other when the handles 110, 116 are brought together and the jaws are in a closed position. When the contact surfaces 128, 130 are brought into abutment, that is, the tool 100 is in a closed position, the contact surfaces 128, 130 may cooperatively define a contact plane 200 that extends from the contact surfaces 128, 130 and through pivot 122. Thus, when the contact surfaces 128, 130 are brought together, they are adapted to remove a hog ring 300 from a manufactured stack 302 of hog rings (such as shown in FIG. 10) or remove or manipulate a hog ring 300 that has been collapsed around a workpiece. The jaw portions 106, 112 may also respectively include first and second back surfaces 140, 142 that are disposed proximal to the pivot 122, and which are adapted to abut each other when the contact surfaces 128, 130 are brought into abutment.

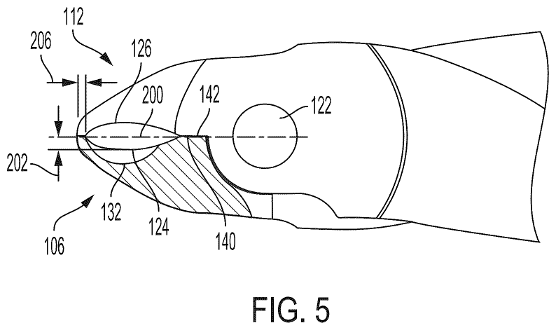

The first and second relief regions 124, 126 may each have an arcuate shape that curves away from the contact plane 200. It will be appreciated that the relief regions 124, 126 may respectively include other geometries. The relief regions 124, 126 may be adapted to grasp and manipulate a hog ring. As shown in FIG. 5, for example, the relief regions may each have a bottom that has a depth 202 from the contact plane 200 to the bottom of the relief region 124, as indicated as 202. The relief regions 124, 126 can have a depth 202 from the contact plane of any distance, such from about 0.005 inches to about 0.500 inches, more preferably about 0.065 inches to about 0.095 inches, and most preferably about 0.080 inches. The shape of the relief portions 124, 126 is generally circular, but other shapes may also be used, while maintaining the functionality of the jaw portions 106, 112. The relief regions 124, 126 may respectively extend from the contact surfaces 128, 130 to the respective back surfaces 140, 142.

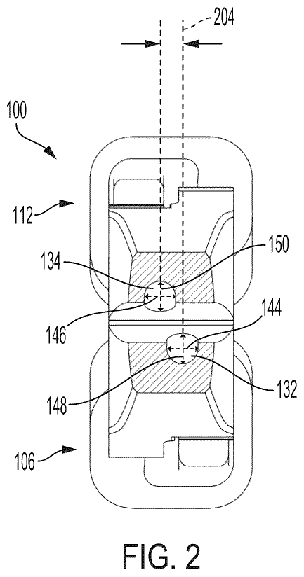

The relief regions 124, 126 may also include respective first and second grooves 132, 134 that are adapted to engage and cooperatively retain a hog ring throughout the process of installing or manipulating the hog ring 300. The grooves 132, 134 have respective first and second groove widths 144, 146 and respective first and second groove depths 148, 150, which are measured from the contact plane 200, as shown in FIG. 2. The grooves 132, 134 may be offset from each other by an offset distance 204. The offset distance 204 may be about 0.010 inches to about 0.188 inches, more preferably about 0.060 inches to about 0.120 inches, and most preferably about 0.090 inches. This offset distance 204 allows for the hog ring to properly collapse, such that the legs of the hog ring do not impinge on one another. As shown in the Figures, the orientation of the grooves 132, 134 is substantially parallel with the longitudinal axis of the tool; however, it will be understood that the grooves 132, 134 may be disposed at an angle to the longitudinal axis of the tool. As shown in the Figures, the depths of the grooves 132, 134 are also substantially perpendicular to the contact plane 200; however, it will be understood that the grooves 132, 134 may be angled toward each other, such that the respective bottoms of the grooves are farther away from each other than the portion of the grooves that are closer to the contact plane 200. In an embodiment, the grooves 132, 134 may each have a substantially arcuate geometry, such that hog rings of various sizes may be retained, with allowance for angular deviations and shape engagements throughout the process of collapsing the hog ring. The grooves 132, 134 may each include a walled portion 135. The walled portion 135 may have a geometry that allows the hog ring 300 to be tilted relative to the contact plane 200 when the hog ring 300 is engaged by the grooves 132, 134.

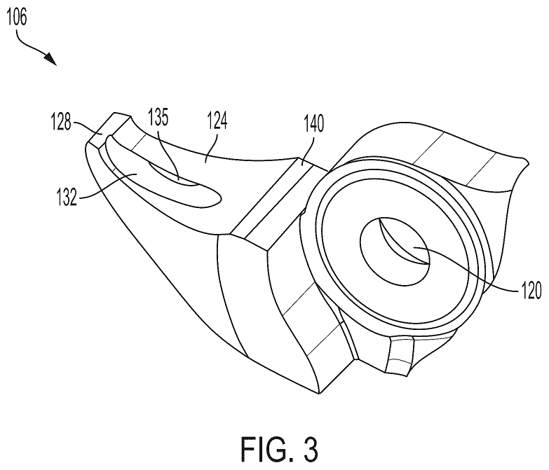

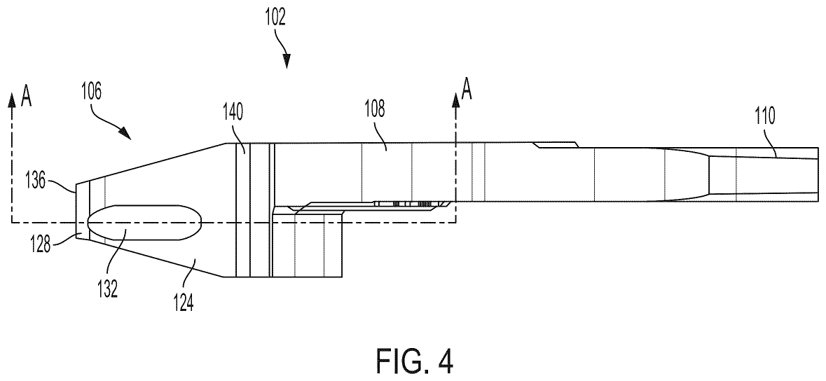

While the grooves 132, 124 have respective groove depths, measured from the contact plane 200 to a bottom of the groove. As shown in the figures, the grooves 132, 134 may have the same groove depths 148, 150 and external geometries. It will also be understood that the grooves 132, 134 may have different groove depths 148, 150 and different external geometries from each other. While the grooves 132, 134 are generally respectively disposed in the relief regions 124, 126, the grooves 132, 134 may respectively abut or partially extend into the contact surfaces 128, 130, as shown in FIGS. 3 and 4.

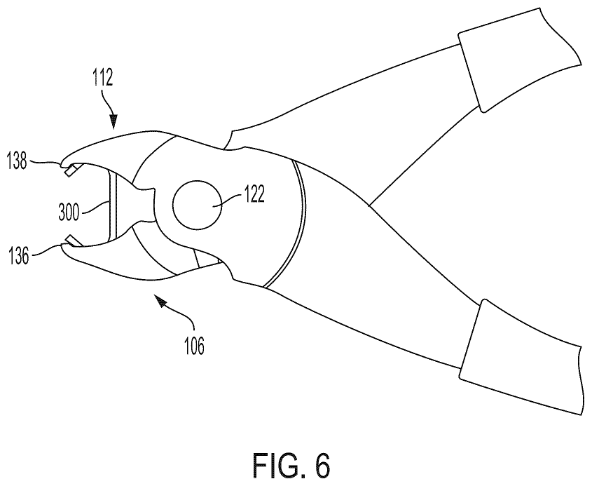

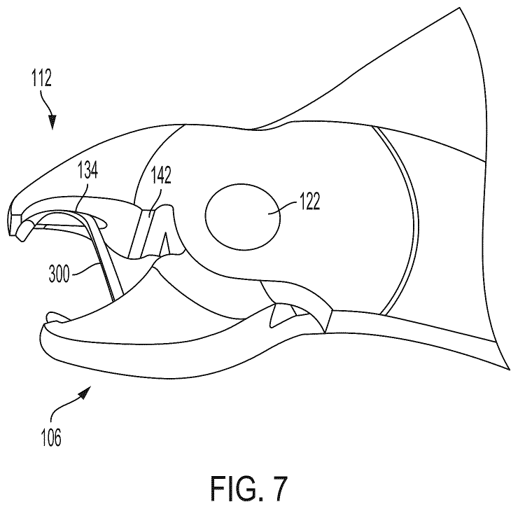

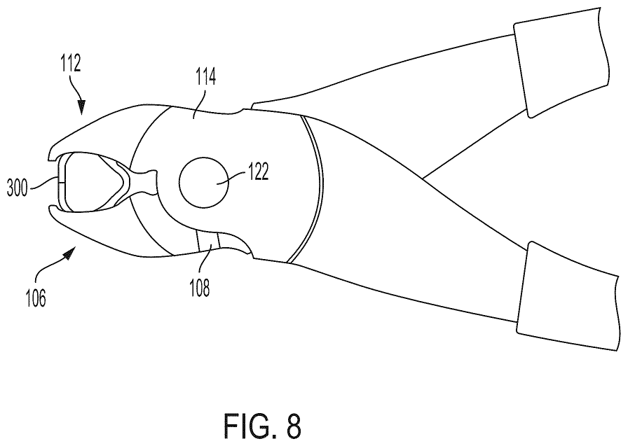

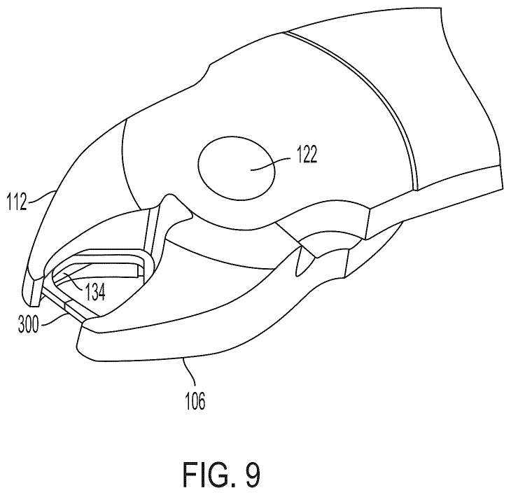

As shown in FIGS. 6 and 7, a hog ring 300 is engaged by the grooves 132, 134 when the tool 100 is in an open position, such that the first and second halves 102, 104 are pivoted relative to each other such that the tool 100 is partially closed to engage the hog ring. The jaw portions 106, 112 may be adapted to engage hog rings 300 that have various sizes and shapes. As shown in FIGS. 6 and 7, the hog ring 300 is in an open position, prior to being collapsed. As shown in FIGS. 8 and 9, the hog ring 300 is engaged by the grooves 132, 134, where the tool 100 has been partially closed; that is, the handles 110, 116 have been moved towards each other so that the jaw portions 106, 112 are also brought closer together. As shown in FIGS. 8 and 9, the hog ring 300 has been collapsed. While not shown, the hog ring 300 may enclose other workpieces or structures to be coupled together. For example, the hog ring 300 may be used to secure integrated rails in automotive seat covers together.

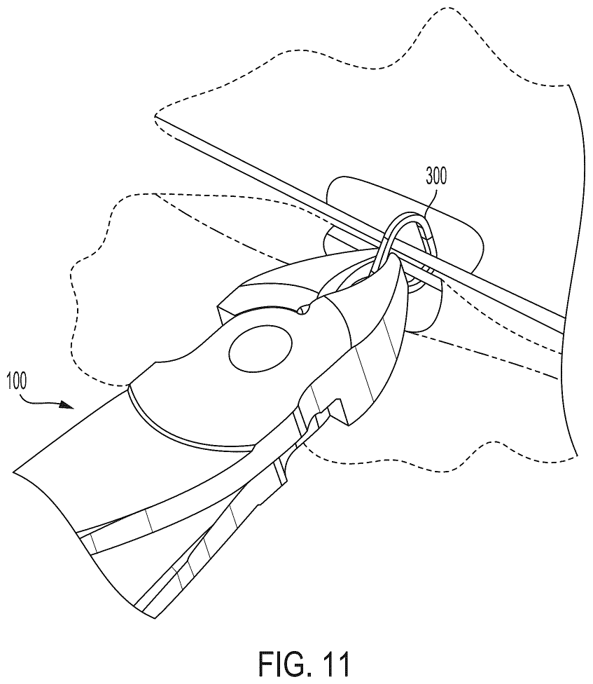

As shown in FIGS. 10 and 11, the tool 100 is adapted to grip and manipulate a hog ring 300, whether it's a pre-manufactured stack 302 of hog rings (such as shown in FIG. 10) or an already installed hog ring 300 that needs to be removed or manipulated. The tool 100 may also be used to grasp and/or manipulate other components or structures.

As used herein, the term “coupled” can mean any physical, electrical, magnetic, or other connection, either direct or indirect, between two parties. The term “coupled” is not limited to a fixed direct coupling between two entities.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

1. A tool comprising:
first and second halves pivotally coupled together at a pivot and respectively having first and second jaw portions having respective first and second front faces;
the first and second jaw portions respectively include first and second contact surfaces respectively disposed proximal to the first and second front faces, and first and second relief regions, and
first and second grooves respectively disposed in the relief regions and that are offset from each other by an offset distance;
wherein when the first and second contact surfaces are brought together, they cooperatively define a contact plane that extends substantially along a longitudinal axis of the tool.

2. The tool of claim 1, wherein each of the relief regions defines a substantially arcuate surface extending from the corresponding contact surface towards the pivot.

3. The tool of claim 1, wherein the groove offset distance is about 0.010 inches to about 0.188 inches.

4. The tool of claim 3, wherein the groove offset distance is about 0.060 inches to about 0.120 inches.

5. The tool of claim 1, wherein the relief regions respectively have relief region depths defined from the corresponding contact plane of about 0.005 inches to about 0.500 inches.

6. The tool of claim 5, wherein each of the relief region depths is about 0.065 inches to about 0.095 inches.

7. The tool of claim 1, wherein the contact surfaces extend along the contact plane a contact surface length of about 0.005 inches to about 0.500 inches.

8. The tool of claim 1, wherein each of the grooves includes a chamfered portion.

9. The tool of claim 1, wherein the grooves are substantially parallel to the longitudinal axis of the tool.

10. The tool of claim 1, further comprising first and second back surfaces that abut each other when the first and second contact surfaces are brought together.

11. A tool for removing, manipulating and installing a hog ring, the tool comprising:
first and second halves pivotally coupled together at a pivot and respectively having first and second jaw portions;
first and second relief regions respectively disposed on the first and second jaw portions;
first and second grooves respectively disposed on the first and second relief portions, wherein the grooves are disposed such that the grooves are offset from each other; and
first and second contact surfaces respectively disposed on the first and second jaw portions, and disposed distal from the pivot.
